(19) United States
(12) Patent Application Publication
(10) Pub. No.: US 2023/0281315 A1
(43) Pub. Date: Sep. 7, 2023

(54) MALWARE PROCESS DETECTION

(71) Applicant: SparkCognition, Inc., Austin, TX (US)

(72) Inventor: Jarred Capellman, Cedar Park, TX (US)

(21) Appl. No.: 17/653,341

(22) Filed: Mar. 3, 2022

(51) Int. Cl. G06F 21/57; G06N 5/00

(52) U.S. Cl. CPC G06F 21/577; G06N 5/003; G06N 20/00

(57) ABSTRACT

A device includes one or more processors configured to monitor activity of a process at a client device, and to generate feature data based at least in part on the monitored activity. The one or more processors are also configured to process, using a machine-learning model, the feature data to generate a risk score. The risk score indicates a likelihood that the process corresponds to malware. The one or more processors are further configured to send the risk score to a management device.

### FIELD

The present disclosure is generally related to determining a likelihood that a process at a client device corresponds to malware.

### BACKGROUND

Malware corresponds to malicious software that can cause disruption to a computer system, gain unauthorized access to information, deprive authorized users access to information or to a system, etc. Malware detection typically involves storing signatures of known malware in a repository and scanning a computer system for files that have signatures that match any of the signatures in the repository. Signature-based malware detection cannot detect zero-day attacks (e.g., previously unknown malware) for which there is no corresponding signature in the repository.

### SUMMARY

In some aspects, a device includes one or more processors configured to monitor activity of a process at a client device, and to generate feature data based at least in part on the monitored activity. The one or more processors are also configured to process, using a machine-learning model, the feature data to generate a risk score. The risk score indicates a likelihood that the process corresponds to malware. The one or more processors are further configured to send the risk score to a management device.

In some aspects, a method includes receiving, at a management device from a client device, a risk score that indicates a likelihood of a process corresponding to malware. The risk score is generated by a machine-learning model based at least in part on monitored activity of the process at the client device. The method also includes, based on determining that the risk score is greater than a risk threshold, sending a command to the client device.

In some aspects, a non-transitory computer-readable medium stores instructions that, when executed by one or more processors, cause the one or more processors to monitor activity of a process at a client device, and to generate feature data based at least in part on the monitored activity. The instructions, when executed by the one or more processors, also cause the one or more processors to process, using a machine-learning model, the feature data to generate a risk score. The risk score indicates a likelihood that the process corresponds to malware. The instructions, when executed by the one or more processors, further cause the one or more processors to send the risk score to a management device.

### BRIEF DESCRIPTION OF THE DRAWINGS

FIG. 1 is a block diagram of a particular illustrative aspect of a system operable to determine a risk score that indicates a likelihood that a process at a client device corresponds to malware, in accordance with some examples of the present disclosure.

FIG. 2 is a diagram of an illustrative aspect of components of a device of the system of

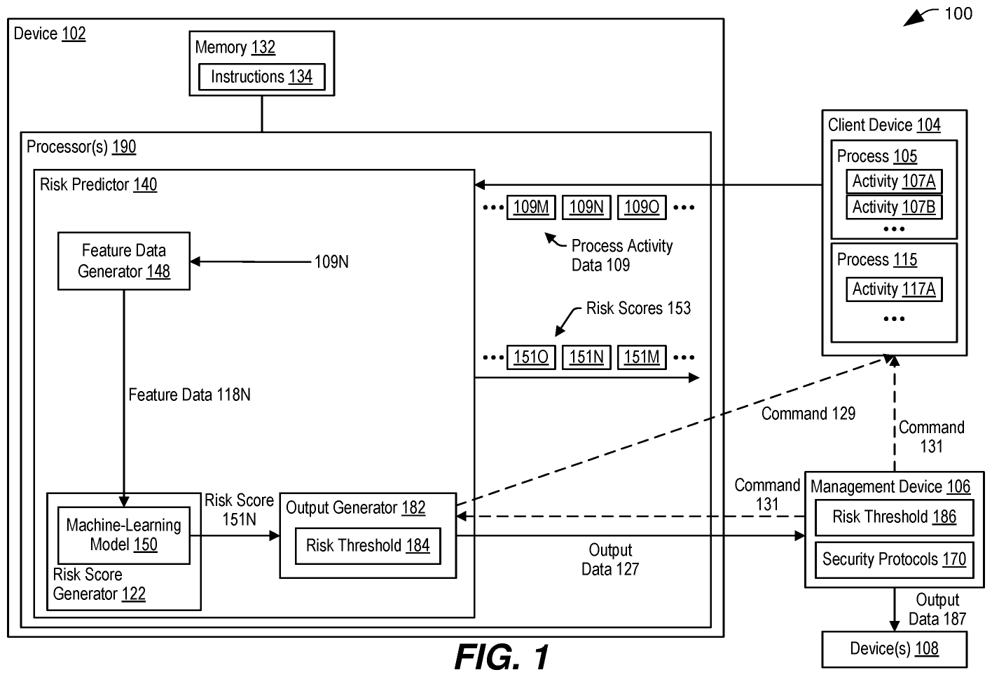

FIG. 1, in accordance with some examples of the present disclosure.

FIG. 3 is a diagram of an illustrative aspect of components of a management device of the system of FIG. 1, in accordance with some examples of the present disclosure.

FIG. 4 is a flow chart of an example of a method of determining a risk score that indicates a likelihood that a process at a client device corresponds to malware.

FIG. 5 is a flow chart of an example of a method of sending a command based on a risk score that indicates a likelihood that a process at a client device corresponds to malware.

### DETAILED DESCRIPTION

Systems and methods are described that enable determining a risk score that indicates a likelihood that a process at a client device corresponds to malware and sending data (e.g., the risk score) to a management device to implement security protocols based on the risk score. To illustrate, a risk predictor monitors activity of a process at the client device. In some examples, the risk predictor is integrated in the client device and generates process activity data indicating the monitored activity of the process. In other examples, the risk predictor is external to the client device and receives the process activity data from the client device.

The process activity data can indicate process initiation, process end, a registry update, a network activity, a file activity, a child process activity, a user activity, or a combination thereof. Based on an analysis of the process activity data, the risk predictor can compute a risk score that indicates a likelihood that the process corresponds to malware. To illustrate, the risk predictor, during training based on activity data associated with known malware, determines particular activities (e.g., accessing particular internet protocol (IP) addresses) that are more strongly associated with the known malware than with non-malware. In these scenarios, the risk predictor generates a higher risk score based on processing activity data indicating one or more activities or a sequence of activities that are similar to activities performed by the known malware.

A device profile of the client device indicates various device features of the client device. For example, the device features can include different types of software installed at the client device, different versions of software installed at the client device, software developer information, different types of hardware included in the client device, hardware manufacturer information, software configuration settings, hardware configuration settings, implemented security settings at the client device, etc. In some examples, the risk predictor has access to a repository of known vulnerability characteristics of the device features and determines the risk score based on the process activity data and the vulnerability characteristics of the device features. For example, the vulnerability characteristics indicate that a particular software (e.g., non-malware software application) installed at the client device stores unencrypted user passwords in a particular file. In this example, the risk predictor can generate a higher risk score in response to a determination that the process attempted to access the particular file and that the process was initiated by another software (e.g., potentially malicious software).

The risk predictor can send the risk score, and corresponding information used to determine the risk score, to a management device. In some examples, the risk predictor can selectively send the risk score, the corresponding process activity data, or both, in response to determining that the risk score exceeds a risk score threshold.

Based on the risk score, the management device can determine whether to initiate security protocols to protect the client device or other devices connected to the client device. As a non-limiting example, if the risk score exceeds a risk score threshold, the management device can send a command to end execution of the process, end execution of one or more child processes, end execution of one or more parent processes, or a combination thereof. As used herein, a “child” process of a particular process refers to a process that is initiated by the particular process or that is initiated by a child process of the particular process. As used herein, a “parent” process of a particular process refers to a process that initiated the particular process or that initiated a process that is a parent process of the particular process. As a further non-limiting example, if the risk score exceeds a risk score threshold, the management device can isolate the client device from a shared network, send a command to change (e.g., heighten) security settings at the client device, or both.

By determining the risk score at the risk predictor and sending the risk score to the management device, a reduced amount of data is communicated to and analyzed at the management device. For example, as opposed to receiving all of the process activity data collected by the risk predictor, the management device can receive the risk score that is based on the process activity data and determine security protocols based on the risk score. In some examples, the risk predictor can send the process activity data in addition to the risk score in response to determining that the risk score is greater than a risk threshold. In these examples, the risk predictor filters the process activity data so that the management device only receives and analyzes process activity data associated with a higher risk score. As a result, the processing efficiency at the management device can be improved.

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, the term “machine-learning” should be understood to have any of its usual and customary meanings within the fields of computers science and data science, such meanings including, for example, processes or techniques by which one or more computers can learn to perform some operation or function without being explicitly programmed to do so. As a typical example, machine-learning can be used to enable one or more computers to analyze data to identify patterns in data and generate a result based on the analysis. For certain types of machine-learning, the results that are generated include data that indicates an underlying structure or pattern of the data itself. Such techniques, for example, include so called “clustering” techniques, which identify clusters (e.g., groupings of data elements of the data).

For certain types of machine-learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine-learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the model includes specifying parameters and hyperparameters of the model. “Hyperparameters” are characteristics of a model that are not modified during training, and “parameters” of the model are characteristics of the model that are modified during training. The term “hyperparameters” may also be used to refer to parameters of the training process itself, such as a learning rate of the training process. In some examples, the hyperparameters of the model are specified based on the task the model is being created for, such as the type of data the model is to use, the goal of the model (e.g., classification, regression, anomaly detection), etc. The hyperparameters may also be specified based on other design goals associated with the model, such as a memory footprint limit, where and when the model is to be used, etc.

Model type and model architecture of a model illustrate a distinction between model generation and model training. The model type of a model, the model architecture of the model, or both, can be specified by a user or can be automatically determined by a computing device. However, neither the model type nor the model architecture of a particular model is changed during training of the particular model. Thus, the model type and model architecture are hyperparameters of the model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, spatial attention layers, convolution layers, etc. While the architecture of a neural network implicitly or explicitly describes links between nodes or layers, the architecture does not specify link weights. Rather, link weights are parameters of a model (rather than hyperparameters of the model) and are modified during training of the model.

In many implementations, a data scientist selects the model type before training begins. However, in some implementations, a user may specify one or more goals (e.g., classification or regression), and automated tools may select one or more model types that are compatible with the specified goal(s). In such implementations, more than one model type may be selected, and one or more models of each selected model type can be generated and trained. A best performing model (based on specified criteria) can be selected from among the models representing the various model types. Note that in this process, no particular model type is specified in advance by the user, yet the models are trained according to their respective model types. Thus, the model type of any particular model does not change during training.

Similarly, in some implementations, the model architecture is specified in advance (e.g., by a data scientist); whereas in other implementations, a process that both generates and trains a model is used. Generating (or generating and training) the model using one or more machine-learning techniques is referred to herein as “automated model building”. In one example of automated model building, an initial set of candidate models is selected or generated, and then one or more of the candidate models are trained and evaluated. In some implementations, after one or more rounds of changing hyperparameters and/or parameters of the candidate model(s), one or more of the candidate models may be selected for deployment (e.g., for use in a runtime phase).

Certain aspects of an automated model building process may be defined in advance (e.g., based on user settings, default values, or heuristic analysis of a training data set) and other aspects of the automated model building process may be determined using a randomized process. For example, the architectures of one or more models of the initial set of models can be determined randomly within predefined limits. As another example, a termination condition may be specified by the user or based on configurations settings. The termination condition indicates when the automated model building process should stop. To illustrate, a termination condition may indicate a maximum number of iterations of the automated model building process, in which case the automated model building process stops when an iteration counter reaches a specified value. As another illustrative example, a termination condition may indicate that the automated model building process should stop when a reliability metric associated with a particular model satisfies a threshold. As yet another illustrative example, a termination condition may indicate that the automated model building process should stop if a metric that indicates improvement of one or more models over time (e.g., between iterations) satisfies a threshold. In some implementations, multiple termination conditions, such as an iteration count condition, a time limit condition, and a rate of improvement condition can be specified, and the automated model building process can stop when one or more of these conditions is satisfied.

Another example of training a previously generated model is transfer learning. “Transfer learning” refers to initializing a model for a particular data set using a model that was trained using a different data set. For example, a “general purpose” model can be trained to detect anomalies in vibration data associated with a variety of types of rotary equipment, and the general purpose model can be used as the starting point to train a model for one or more specific types of rotary equipment, such as a first model for generators and a second model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. Often, transfer learning can converge to a useful model more quickly than building and training the model from scratch.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As another example, to use supervised training to train a model to perform a classification task, each data element of a training data set may be labeled to indicate a category or categories to which the data element belongs. In this example, during the creation/training phase, data elements are input to the model being trained, and the model generates output indicating categories to which the model assigns the data elements. The category labels associated with the data elements are compared to the categories assigned by the model. The computer modifies the model until the model accurately and reliably (e.g., within some specified criteria) assigns the correct labels to the data elements. In this example, the model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that the during the runtime phase, the model is configured to determine which of multiple unlabeled “clusters” an input data sample is most likely to belong to.

As another example, to train a model to perform a regression task, during the creation/training phase, one or more data elements of the training data are input to the model being trained, and the model generates output indicating a predicted value of one or more other data elements of the training data. The predicted values of the training data are compared to corresponding actual values of the training data, and the computer modifies the model until the model accurately and reliably (e.g., within some specified criteria) predicts values of the training data. In this example, the model can subsequently be used (in a runtime phase) to receive data elements and predict values that have not been received. To illustrate, the model can analyze time series data, in which case, the model can predict one or more future values of the time series based on one or more prior values of the time series.

In some aspects, the output of a model can be subjected to further analysis operations to generate a desired result. To illustrate, in response to particular input data, a classification model (e.g., a model trained to perform classification tasks) may generate output including an array of classification scores, such as one score per classification category that the model is trained to assign. Each score is indicative of a likelihood (based on the model's analysis) that the particular input data should be assigned to the respective category. In this illustrative example, the output of the model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

Referring to FIG. 1, a system operable to determine a risk score that indicates a likelihood that a process at a client device corresponds to malware is shown and generally designated 100. The system 100 includes a device 102, a client device 104, and a management device 106. The device 102 includes a risk predictor 140.

The client device 104 is configured to send process activity data 109 to the risk predictor 140. The process activity data 109 can include time-series data, such as process activity data 109M, process activity data 109N, process activity data 109O, one or more additional sets of process activity data, or a combination thereof. In a particular aspect, each set of the process activity data 109 indicates one or more activities of a process detected at the client device 104. For example, the process activity data 109M indicates that an activity 107A of a process 105 is detected at a first time at the client device 104. In some aspects, the client device 104 can poll different components of the client device 104 (e.g., storage devices, data logs, processing logs, data bus, etc.) to collect the process activity data 109.

In some examples, more than one set of process activity data can be associated with the same process. As an illustrative example, the process activity data 109M indicates that the activity 107A of the process 105 is detected at the first time at the client device 104, and the process activity data 109N indicates that an activity 107B of the process 105 is detected at a second time at the client device 104. In a particular aspect, the second time is subsequent to the first time.

In some examples, sets of process activity data can be associated with different processes at the client device 104. As an illustrative example, the process activity data 109N indicates that the activity 107B of the process 105 is detected at the second time at the client device 104, and the process activity data 109O indicates that an activity 117A of a process 115 is detected at a third time at the client device 104. In a particular aspect, the third time is subsequent to the second time.

The risk predictor 140 is configured to generate one or more risk scores 153 based on the process activity data 109 and initiates sending of output data 127 via a communication interface to the management device 106. For example, the risk predictor 140 generates a risk score 151M, a risk score 151N, and a risk score 1510 based on the process activity data 109M, the process activity data 109N, and the process activity data 109O, respectively. For example, the output data 127 can include the risk score 153N indicating a likelihood that the process 105 at the client device 104 corresponds to malware. Based on the one or more risk scores 153, the management device 106 can identify security protocols 170 to be implemented at the client device 104, the system 100, or both.

The client device 104 can correspond to any electronic device that communicates over a network or any electronic device that is subjectable to a malware attack. According to some implementations, the client device 104 can fall within different classifications. As non-limiting examples, the classification of the client device 104 can correspond to at least one of a governmental agency device, a military department device, a banking system device, a school system device, a business device, or a personal device. As described below, the security protocols 170 can be based at least in part on the classification of the client device 104. For example, relatively strict security protocols 170 can be implemented if the client device 104 is a governmental agency device, and relatively lax security protocols 170 can be implemented if the client device 104 is a personal device.

The device 102 includes a memory 132 coupled to one or more processors 190. The one or more processors 190 include the risk predictor 140. The memory 132 can be a non-transitory computer-readable medium (e.g., a storage device) that includes instructions 134 that are executable by the one or more processors 190 to perform the operations described herein. The device 102 can include a communication interface, such as a receiver, transmitter, a transceiver, or another type of communication interface, that is configured to communicate with the client device 104, the management device 106, or both. It should be understood that the device 102 illustrated in FIG. 1 can include additional components and that the components illustrated in FIG. 1 are merely for ease of description.

In some aspects, the client device 104 includes a memory coupled to one or more processors. In a particular aspect, the memory of the client device 104 can be a non-transitory computer-readable medium (e.g., a storage device) that includes instructions that are executable by the one or more processors of the client device 104 to perform operations described herein with reference to the client device 104. The one or more processors of the client device 104 are configured to execute one or more processes, such as the process 105, the process 115, one or more additional processes, or a combination thereof. The one or more processors of the client device 104 are configured to monitor activity of the one or more processes and to generate the process activity data 109 indicating the monitored activity. The client device 104 can include a communication interface, such as a receiver, transmitter, a transceiver, or another type of communication interface, that is configured to communicate with the device 102, the management device 106, or both. It should be understood that the client device 104 illustrated in FIG. 1 can include additional components and that the components illustrated in FIG. 1 are merely for ease of description.

In some aspects, the management device 106 includes a memory coupled to one or more processors, as further described with reference to FIG. 3. In a particular aspect, the memory of the management device 106 can be a non-transitory computer-readable medium (e.g., a storage device) that includes instructions that are executable by the one or more processors of the management device 106 to perform operations described herein with reference to the management device 106. The one or more processors of the management device 106 are configured to identify the security protocols 170 to be implemented. The management device 106 can include a communication interface, such as a receiver, transmitter, a transceiver, or another type of communication interface, that is configured to communicate with the device 102, the client device 104, or both. It should be understood that the management device 106 illustrated in FIG. 1 can include additional components and that the components illustrated in FIG. 1 are merely for ease of description.

The risk predictor 140 includes a feature data generator 148, a risk score generator 122, and an output generator 182. According to one implementation, one or more of the components of the one or more processors 190 can be implemented using dedicated hardware, such as an application-specific integrated circuit (ASIC) or a field programmable gate array (FPGA). According to other implementations, one or more of the components of the one or more processors 190 can be implemented by executing the instructions 134 stored in the memory 132.

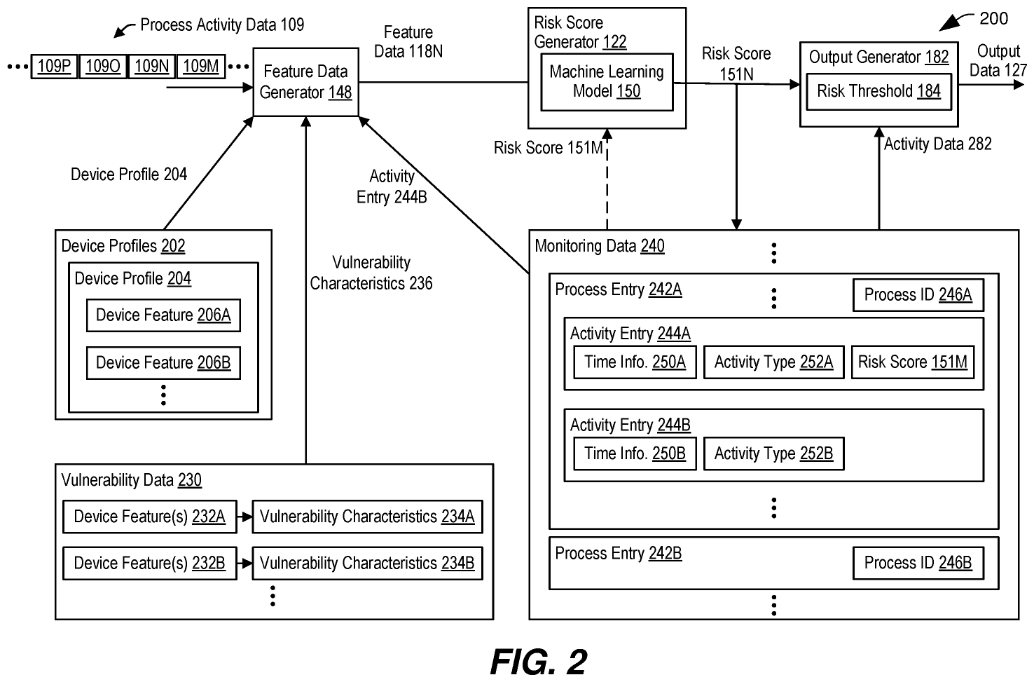

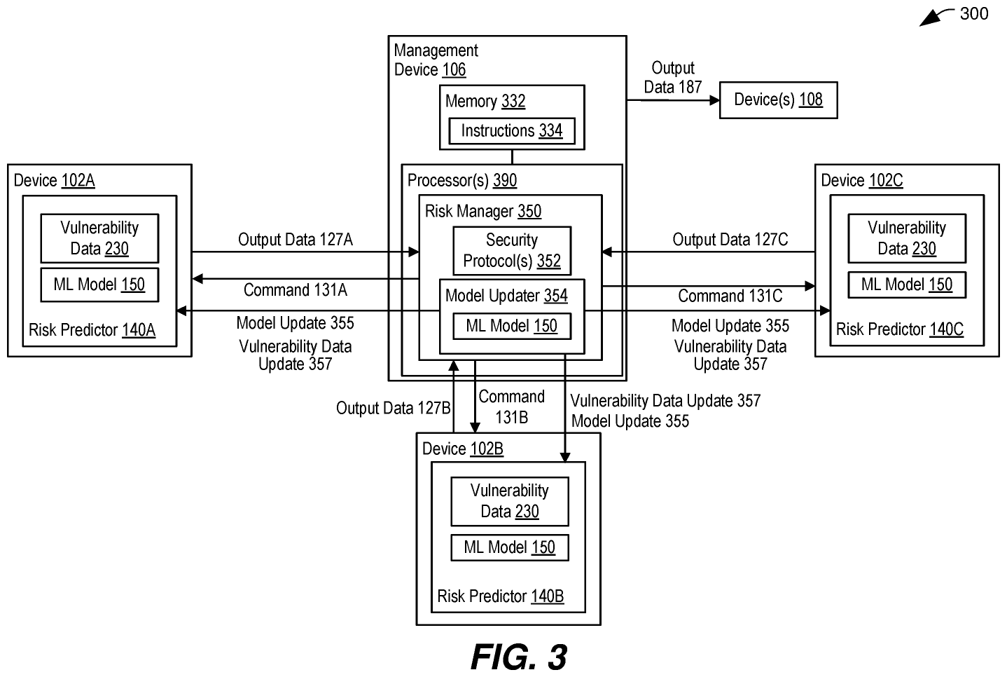

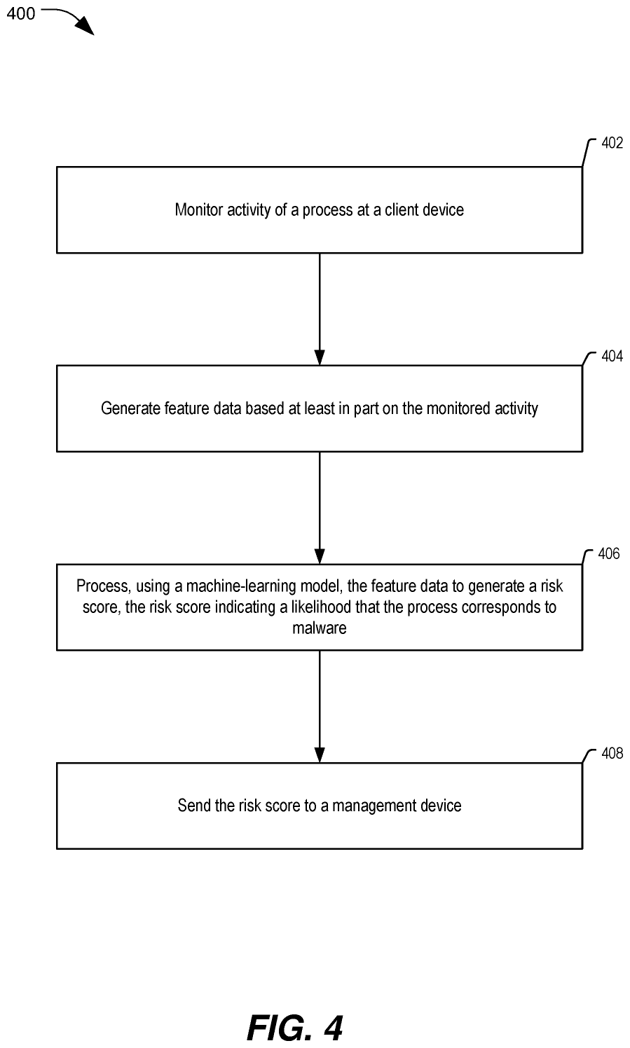

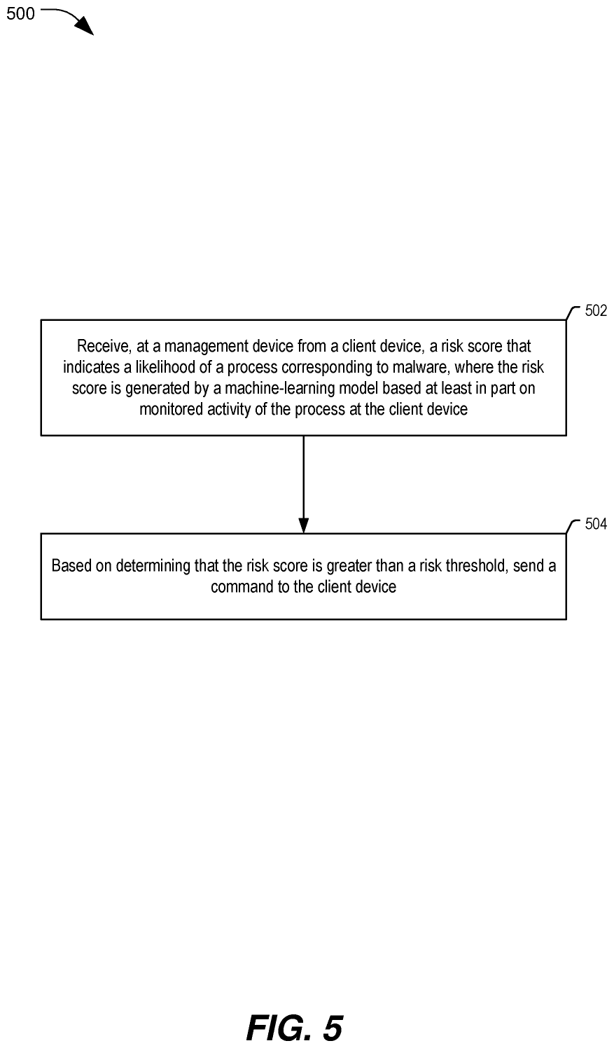

In some aspects, the feature data generator 148 is configured to monitor activity of one or more processes at the client device 104. For example, the feature data generator 148 is configured to receive the process activity data 109 indicating the monitored activity. The feature data generator 148 is configured to generate feature data based on the process activity data 109, as further described with reference to FIG. 2. For example, the feature data generator 148 is configured to generate feature data 118N based at least in part on the process activity data 109N. The process activity data 109N indicates that the activity 107B of the process 105 is detected at the client device 104.

In some implementations, the feature data 118N includes a vector of feature values. For example, a first value of a first feature of the feature data 118N indicates an activity type of the activity 107A. The activity type can include process initiation, process end, a registry update, a network activity, a file activity, a child process activity, a user activity, or a combination thereof. In a particular aspect, a second value of a second feature of the feature data 118N can indicate one or more parameters of the activity 107A. In a particular aspect, a third value of a third feature of the feature data 118N indicates a process identifier, a process type, or both, of the process 105.

In an illustrative example, the first value of the first feature indicates that the activity 107B includes file access, the second value of the second feature indicates a filename, a file type, or both, of a file that is accessed during the activity 107B, and the third value of the third feature indicates a process identifier of the process 105. Activity type, parameters, and process identifier are provided as illustrative examples of features. In other examples, the feature data 118N can include feature values of one or more additional features. For example, the feature data 118N can include a previously determined risk score associated with the process 105. To illustrate, a feature value of the feature data 118N can correspond to the risk score 151M. As another example, the feature data 118N can include a signature of a file (e.g., an executable) associated with the process 105.

The risk score generator 122 is configured to determine the risk score 151N based on the feature data 118N. The risk score 151N indicates a likelihood that the process 105 at the client device 104 corresponds to malware. In a particular aspect, the risk score generator 122 includes a machine-learning model 150 (e.g., a decision tree model or a gradient boost model) and the feature data 118N corresponds to an input embedding of the machine-learning model 150. The risk score generator 122 uses the machine-learning model 150 to process the feature data 118N to generate the risk score 151N. To illustrate, the machine-learning model 150 is trained on training data including process activity data associated with processes that are malware as well as process activity data associated with processes that are not malware.

The machine-learning model 150, during training, assigns weights to features of the training data to generate a higher risk score for feature values that are more strongly associated with process activity data of malware processes and a lower risk score for feature values that are more strongly associated with process activity data of non-malware processes. In some aspects, the machine-learning model 150 can be trained to find correlations between feature values and malware (or non-malware) processes that might not be obvious or previously known to a person. In some implementations, the management device 106 can dynamically update the machine-learning model 150, as further described with reference to FIG. 3.

The risk score generator 122 provides the risk score 151N to the output generator 182. The output generator 182 generates output data 127 based on the risk score 151N, the feature data 118N, the process activity data 109N, or a combination thereof. For example, the output generator 182 generates the output data 127 indicating the risk score 151N. In a particular implementation, the output generator 182 generates the output data 127 selectively based on the process activity data 109N, the feature data 118N, or both. For example, the output generator 182, in response to determining that the risk score 151N exceeds a risk threshold 184, generates the output data 127 indicating the process activity data 109N, the feature data 118N, or both, in addition to the risk score 151N. In an alternative implementation, the output generator 182 generates the output data 127 indicating the risk score 151N, the process activity data 109N, and the feature data 118N independently of whether the risk score 151N exceeds the risk threshold 184. The output generator 182 provides the output data 127 to the management device 106.

In some implementations, the output generator 182, in response to determining that the risk score 151N exceeds the risk threshold 184, sends a command 129 to the client device 104 to end the process 105, end one or more child processes of the process 105, end one or more parent processes of process 105, or a combination thereof. In a particular example, when at least one risk score (e.g., the risk score 151N) associated with the process 105 exceeds the risk threshold 184 and all risk scores (e.g., the risk score 1510) associated with the process 115 are less than or equal to the risk threshold 184, the output generator 182 can send the command 129 to end the process 105 while the process 115 continues executing at the client device 104. The risk score generator 122 thus enables implementation of targeted security protocols.

The management device 106 is configured to receive the output data 127 from the risk predictor 140. Based on the output data 127, the management device 106 is configured to identify security protocols 170 to be implemented at the device 102, the client device 104, the system 100, or a combination thereof. For example, the management device 106 can determine how likely it is that the client device 104 is subject to a malware attack from the process 105 based on the risk score 151N and can implement security measures based on the likelihood. To illustrate, the management device 106 can select the security protocols 170 in response to determining that the risk score 151N exceeds a risk threshold 186. In some aspects, the risk threshold 186 is the same as the risk threshold 184. In some aspects, the risk threshold 186 is different from (e.g., greater than) the risk threshold 184. The risk threshold 184, the risk threshold 186, or both, can be based on a configuration setting, user input, or default data.

According to some implementations, the security protocols 170 to be implemented include ending the process 105, ending one or more child processes of the process 105, ending one or more parent processes of the process 105, or a combination thereof. To illustrate, the security protocols 170 can include ending an application process that is a parent process of the process 105 and exclude ending an operating system process that is a parent process of the process 105. In some examples, the security protocols 170 include a security setting. For example, the security protocols 170 can include changing the security setting from a low security setting to a high (e.g., recommended) security setting. According to other implementations, the security protocols 170 to be implemented can include isolating the client device 104 from a shared network. For example, if the client device 104 is connected to a similar network as other devices, the management device 106 can instruct the client device 104 to leave the network as to not subject the other devices to potential malware attacks.

The management device 106 is configured to generate a command 131 that identifies the security protocols 170, and to send the command 131 to the device 102, the client device 104, or both. In some implementations in which the management device 106 sends the command 131 to the device 102, the device 102 sends a command 129 to the client device 104 in response to receiving the command 131. For example, the command 129 indicates the security protocols 170. In some implementations, the management device 106 sends the command 131 to the client device 104. The client device 104, in response to receiving the command 131, the command 129, or both, can implement the security protocols 170 at the client device 104.

In some scenarios, the command 131 is based on a classification of the client device 104. As described above, the classification of the client device 104 can correspond to at least one of a governmental agency device, a military department device, a banking system device, a school system device, a business device, a personal device, etc. In the scenario where the client device 104 is a military department device, the security protocols 170 identified in the command 131 can instruct the client device 104 to isolate from shared networks, as a malware attack on a military department device may compromise national security and should be treated in a serious manner. However, in the scenario where the client device 104 is a personal device, the security protocols 170 identified in the command 131 can instruct the client device 104 to change a security setting to a recommended security setting.

In some implementations, the management device 106 generates output data 187 based on the output data 127. For example, the output data 187 indicates the risk score 151N of the process 105. In some examples, the management device 106, in response to determining that the risk score 151N exceeds the risk threshold 186, generates the output data 187 based on the process activity data 109N, the feature data 118N, or both. For example, the output data 187 indicates the activity 107B, the process 105, the features and corresponding feature values indicated by the feature data 118N, or a combination thereof, that resulted in the risk score 151N that exceeded the risk threshold 186. In a particular implementation, the output data 127, the output data 187, or both, indicate the weights applied by the risk score generator 122 to the feature values of the features indicated by the feature data 118N to determine the risk score 151N. In some examples, the output data 187 indicates the security protocols 170 to be implemented.

In some implementations, the management device 106 sends the output data 187 to one or more devices 108. In a particular aspect, the one or more devices 108 include a storage device, a user device, a communication device, a network device, a display device, or a combination thereof. For example, the output data 187 corresponds to an alert sent to a device of a network security administrator. As another example, the output data 187 is sent to a storage device to add to a network security log. In some examples, the output data 187 indicates a count (e.g., top five) features that are weighed the highest in determining the risk score 151N. The output data 187 can thus enable traceability of the risk score 151N to features and feature values that triggered the security protocols 170.

The system 100 of FIG. 1 enables detecting malware based on process activity. For example, the machine-learning model 150 can be used to detect zero-day malware that could be missed using signature-based malware detection. In some implementations, the risk predictor 140 is used in conjunction with signature-based malware detection. For example, a signature-based malware detector determines whether a signature of any software installed at the client device 104 matches a signature of known malware, and the risk predictor 140 monitors process activity at the client device 104 to detect malware.

The system 100 also improves processing efficiency at the management device 106 by reducing the amount of data that the management device 106 has to filter through to determine whether a process at the client device 104 corresponds to malware. For example, instead of sending an expansive amount of data (e.g., the process activity data 109) for all processes of the client device 104 to the management device 106, the risk score generator 122 can perform a determination of the risk score 151N and send data indicative of the risk score 151N (e.g., the output data 127) to the management device 106 and selectively send additional data (e.g., based on the process activity data 109N, the feature data 118N, or both) when the risk score 151N exceeds the risk threshold 184. Thus, the management device 106 receives a relatively small amount of data associated with the process 105 when the risk score 151N exceeds the risk threshold 184 and can determine the appropriate security protocols 170 based on the small amount of data.

The risk predictor 140 generating the risk score 151M, the risk score 151N, and the risk score 1510 corresponding to the process activity data 109M, the process activity data 109N, and the process activity data 109O, respectively, is provided as an illustrative example. In some examples, the risk predictor 140 can generate one or more additional risk scores independently of receiving updates of the process activity data. For example, the risk predictor 140 can recompute the risk score associated with the process activity data 109N to generate a risk score 151NA (not shown) subsequent to generating the risk score 151N. The risk predictor 140 can generate the risk score 151NA independently of (e.g., without or prior to) receiving the process activity data 109O.

As an illustrative example, the risk predictor 140 can generate the risk score 151NA in response to detecting that a time interval subsequent to generating the risk score 151N has expired, that a device profile of the client device 104 is updated, that vulnerability data is updated, that the machine learning model 150 is updated, that an instruction is received from a management server, or a combination thereof. In some aspects, the feature data generator 148 generates updated feature data 118NA (not shown) based on updates to the device profile, the vulnerability data, or both. In some aspects, the risk predictor 140 updates (e.g., adjusts weights, biases, or both of) the machine learning model 150. The risk score generator 122 generates the risk score 151NA based on the updated feature data 118NA, the updated version of the machine learning model 150, or a combination thereof. The risk predictor 140 can perform one or more operations based on the risk score 151NA that are similar to operations described with reference to the risk score 151N. For example, the risk score generator 122 can provide the risk score 151NA to the output generator 182.

The device 102 and the client device 104 are shown as separate devices as an illustrative implementation. In some implementations, the device 102 and the client device 104 can correspond to a single device. For example, in these implementations, one or more components (e.g., the risk predictor 140, the one or more processors 190, the memory 132, or a combination thereof) described with reference to device 102 are integrated in the client device 104.

Referring to FIG. 2, a diagram 200 of an illustrative aspect of components of the device 102 of FIG. 1 is shown. The feature data generator 148 is configured to monitor activity of processes at one or more client devices of the system 100, and to generate feature data based on the monitored activity.

As an example, the feature data generator 148, in response to receiving the process activity data 109M indicating that the activity 107A of the process 105 is detected at the client device 104 and determining that the activity 107A corresponds to initiation of the process 105, adds a process entry 242A to monitoring data 240 and adds an activity entry 244A to the process entry 242A. The process entry 242A indicates a process identifier 246A of the process 105. The activity entry 244A indicates time information 250A, an activity type 252A of the activity 107A, or both. For example, the time information 250A indicates a time at which the process 105 is initiated at the client device 104, a time at which the process activity data 109M is received by device 102, a time at which the process activity data 109M is received at the risk score generator 122, a time at which the process activity data 109M is received at the feature data generator 148, or a combination thereof. The activity type 252A indicates process initiation, the activity 107A, or both.

As another example, the feature data generator 148, in response to receiving the process activity data 109N indicating that the activity 107B of the process 105 is detected at the client device 104 and determining that the monitoring data 240 includes the process entry 242A indicating the process identifier 246A of the process 105, adds an activity entry 244B to the process entry 242A. The activity entry 244B indicates time information 250B, an activity type 252B of the activity 107B, or both. For example, the time information 250B indicates a time at which the activity 107B is detected at the client device 104, a time at which the process activity data 109N is received by device 102, a time at which the process activity data 109N is received at the risk score generator 122, a time at which the process activity data 109N is received at the feature data generator 148, or a combination thereof. The activity type 252B can indicate a process end, a registry update, a network activity, a file activity, a child process activity, a user activity, another type of activity of the process 105, or a combination thereof.

As a further example, the feature data generator 148, in response to receiving the process activity data 109O indicating that the activity 117A of the process 115 is detected at the client device 104 and determining that the activity 117A corresponds to initiation of the process 115, adds a process entry 242B to the monitoring data 240 and adds an activity entry to the process entry 242B. The process entry 242B indicates a process identifier 246B of the process 115. The feature data generator 148 may add one or more activity entries to the process entry 242B based on additional process activity data associated with the process 115.

In a particular example, the activity type 252B of the activity 107B of the process 105 indicates initiation of a child process (e.g., the process 115) by the process 105. In this example, the process entry 242A has a reference to the process entry 242B, the process entry 242B has a reference to the process entry 242A, or both. For example, the process entry 242A has a child field indicating the process entry 242B, the process entry 242B has a parent field indicating the process entry 242A, or both.

The feature data generator 148 has access to one or more device profiles 202 of client devices of the system 100, and to vulnerability data 230 that maps device features to vulnerability characteristics. For example, a device profile 204 of the client device 104 indicates a device feature 206A, a device feature 206B, one or more additional device features, or a combination thereof, of the client device 104. Device features of the device profile 204 can include a type of installed software, a version of the installed software, a developer of the installed software, a type of hardware, a manufacturer of the hardware, a hardware configuration, a configuration setting, a security setting, or a combination thereof, of the client device 104. In a particular aspect, the feature data generator 148 receives the device profile 204 from the client device 104.

The feature data generator 148 has access to vulnerability data 230 that maps device features to vulnerability characteristics. For example, the vulnerability data 230 indicates that one or more device features 232A map to vulnerability characteristics 234A, one or more device features 232B map to vulnerability characteristics 234B, one or more additional sets of features map to one or more additional vulnerability characteristics, or a combination thereof. For example, the vulnerability data 230 indicates that one or more device features 232A, such as a specific version of a particular software (e.g., a software library, such as Log4j), has vulnerability characteristics 234A (e.g., allows remote code execution by user input of a specific string in a text box). As another example, the vulnerability data 230 indicates that one or more device features 232B (e.g., a particular software) has vulnerability characteristics 234B (e.g., stores unencrypted passwords in a particular password file).

In a particular aspect, the feature data generator 148 receives the vulnerability data 230 from the management device 106, a storage device, a network device, or a combination thereof.

The feature data generator 148 performs a comparison of the device features of the device profile 204 and the device features of the vulnerability data 230 to determine vulnerability characteristics 236 of the client device 104. To illustrate, the feature data generator 148, in response to determining that the device feature 206A matches the one or more device features 232A (e.g., a software installed at the client device 104 uses the software library Log4j), adds the vulnerability characteristics 234A (e.g., allows remote code execution by user input of a specific string in a text box) to the vulnerability characteristics 236. In a particular aspect, the feature data generator 148, in response to determining that the device feature 206B matches the one or more device features 232B (e.g., the particular software is installed at the client device 104), adds the vulnerability characteristics 234B (e.g., stores unencrypted passwords in a particular password file) to the vulnerability characteristics 236.

The feature data generator 148 generates feature data based on the process activity data 109 of the client device 104, the device profile 204 of the client device 104, the vulnerability characteristics 236, or a combination thereof. For example, the feature data generator 148, in response to receiving the process activity data 109N, generates the feature data 118N based on the activity entry 244B, the device profile 204, the vulnerability characteristics 236, or a combination thereof. For example, a first feature value of a first feature of the feature data 118N is based on the vulnerability characteristics 236 (e.g., allows remote code execution by user input of a specific string in a text box), and a second feature value of a second feature of the feature data 118N is based on the activity type 252B (e.g., user input), one or more parameters (e.g., a particular string entered in a text box) of the activity 107B indicated by the activity entry 244B, or both.

In some implementations, the feature data generator 148 generates the feature data 118N further based on one or more previous activity entries (e.g., the activity entry 244A) associated with the process 105. In other implementations, the machine-learning model 150 retains a state from a previous processing of feature data associated with the process 105. Having information about previous activity of the process 105 can enable the machine-learning model 150 to detect patterns that match patterns of activity associated with known malware. The patterns of activity (e.g., various feature correlations) associated with known malware may be reflected in configuration of (e.g., weights and biases of nodes of) the machine-learning model 150 during training. For example, during training of the machine-learning model 150, feature values representing particular attempted file accesses, particular attempted network accesses, or a combination thereof, that correspond to known malware may correspond to a higher risk score.

The risk score generator 122 uses the machine-learning model 150 to process the feature data 118N to generate the risk score 151N. For example, the machine-learning model 150 generates the risk score 151N indicating a high likelihood that the process 105 corresponds to malware when the first feature value of the first feature indicates the vulnerability characteristics 236 (e.g., allows remote code execution by user input of a specific string in a text box) matches the one or more parameters (e.g., the specific string entered in a text box) of the activity 107B indicated by the second feature value of the second feature (e.g., user input indicating the specific string entered in a text box).

In some aspects, the risk score generator 122 determines the risk score 151N based on one or more previously generated risk scores associated with the process 105, the client device 104, or both. In some implementations, the risk score generator 122 uses the machine-learning model 150 to process the feature data 118N based on the risk score 151M. In other implementations, the feature data generator 148 generates the feature data 118N based on the risk score 151M. In some aspects, if the risk score 151M exceeds a first threshold, the risk score 151N is higher than the risk score 151N would be if the risk score 151M was less than or equal to the first threshold. In some aspects, if the risk score 151M is less than a second threshold, the risk score 151N is lower than the risk score 151N would be if the risk score 151M was greater than or equal to the second threshold.

In some aspects, the risk score generator 122 updates the activity entry 244B to indicate the risk score 151N. The risk score generator 122 provides the risk score 151N to the output generator 182. In some implementations, the output generator 182, in response to determining that the risk score 151N exceeds the risk threshold 184, generates activity data 282 based on one or more activity entries (e.g., the activity entry 244A, the activity entry 244B, one or more additional activity entries, or a combination thereof) of the process entry 242A corresponding to the process 105. The risk score generator 122 generates the output data 127 based on the risk score 151N and the activity data 282.

In a particular aspect, performing the security protocols 170 of FIG. 1 in response to detecting that the process 105 corresponds to malware, as described with reference to FIG. 1, includes ending the process 115 in addition to ending the process 105. For example, the output generator 182 of FIG. 1, in response to determining that the command 131 indicates that any child process of the process 105 is to end and determining that the monitoring data 240 indicates that the process 115 is a child process of the process 105, generates the command 129 indicating that the process 115 is to end. In a particular aspect, the output generator 182, in response to determining that a child field of the process entry 242A indicates the process entry 242B, a parent field of the process entry 242B indicates the process entry 242A, or both, determines that the process 115 having the process identifier 246B indicated by the process entry 242B is a child process of the process 105 having the process identifier 246A indicated by the process entry 242A.

In some implementations, the feature data generator 148, in response to receiving process activity data 109P indicating that the process 105 is ended at the client device 104 and determining that the process entry 242A has the process identifier 246A of the process 105, removes the process entry 242A from the monitoring data 240. In other implementations, the feature data generator 148, in response to receiving the process activity data 109P indicating that the process 105 is ended at the client device 104 and determining that the process entry 242A has the process identifier 246A of the process 105, adds an activity entry to the process entry 242A with an activity type (e.g., end process) indicating that the process 105 has ended.

The feature data generator 148 enables tracking process activity by maintaining the monitoring data 240. The feature data generator 148 also enables input (e.g., the feature data 118N) to the machine-learning model 150 to take account of known vulnerability characteristics of device features of the client device 104 in addition to the process activity.

The feature data generator 148 generating the feature data 118N in response to receiving the process activity data 109N is provided as an illustrative example. In some examples, the feature data generator 148 generates feature data 118NA (not shown) in response to detecting an update of the device profile 204, an update of the vulnerability characteristics 236, an update of the machine learning model 150, an expiration of a timer subsequent to generating the feature data 118N, an instruction from a management server, or a combination thereof, as described with reference to FIG. 1. The feature data generator 148 performs one or more operations based on the feature data 118NA that are similar to operations described with reference to the feature data 118N. For example, the feature data generator 148 provides the feature data 118NA to the risk score generator 122. In some aspects, the risk score generator 122 generates a risk score 151NA (not shown) based on the feature data 118NA and at least one previous risk score (e.g., the risk score 151N). The output generator 182 generates output data based on the risk score 151NA and the activity data 282.

Referring to FIG. 3, a diagram 300 of an illustrative aspect of components of the management device 106 is shown. The management device 106 includes a memory 332 coupled to one or more processors 390.

The one or more processors 390 include a risk manager 350. The memory 332 can be a non-transitory computer-readable medium (e.g., a storage device) that includes instructions 334 that are executable by the one or more processors 390 to perform the operations described herein. The management device 106 can include a communication interface, such as a receiver, transmitter, a transceiver, or another type of communication interface, that is configured to communicate with a device 102A, a device 102B, a device 102C, the client device 104, one or more additional devices, or a combination thereof. It should be understood that the management device 106 illustrated in FIG. 3 can include additional components and that the components illustrated in FIG. 3 are merely for ease of description.

The risk manager 350 receives output data 127A, output data 127B, and output data 127C from the device 102A, the device 102B, and the device 102C, respectively. The device 102A includes a risk predictor 140A. The device 102B includes a risk predictor 140B. The device 102C includes a risk predictor 140C.

In a particular aspect, the device 102 of FIG. 1 represents one or more of the device 102A, the device 102B, or the device 102C. The risk predictor 140 of FIG. 1 represents the corresponding one or more of the risk predictor 140A, the risk predictor 140B, or the risk predictor 140C. The output data 127 of FIG. 1 represents the corresponding one or more of the output data 127A, the output data 127B, or the output data 127C.

Each of the output data 127A, the output data 127B, and the output data 127C indicates a respective risk score indicating a likelihood that a process at an associated client device corresponds to malware. For example, the output data 127A indicates a first risk score indicating a likelihood that a first process at a first client device corresponds to malware. The output data 127B indicates a second risk score indicating a likelihood that a second process at a second client device corresponds to malware. The output data 127C indicates a third risk score indicating a likelihood that a third process at a third client device corresponds to malware. In a particular aspect, the first client device includes the device 102A, the second client device includes the device 102B, and the third client device includes the device 102C.

In some aspects, one or more of the output data 127A, the output data 127B, or the output data 127C include activity data indicating one or more process activities that resulted in the respective risk score. For example, the output data 127A includes first activity data indicating one or more first activities that resulted in the first risk score. In some implementations, the output data 127A includes the first activity data if the first risk score exceeds the risk threshold 184, as described with reference to FIG. 1.

The risk manager 350 based on the first risk score, the second risk score, third risk score, one or more additional risk scores, or a combination thereof, selects one or more security protocols 352 to be implemented at the system 100 of FIG. 1. For example, the one or more security protocols 352 include sending an end process command to one or more of the client devices, sending a security setting change command to one or more of the client devices, isolating one or more of the client devices from a shared network, sending an alert to a user device, displaying output data indicating one or more first activities of the first process that resulted in the first risk score, or a combination thereof.

In a particular aspect, the risk manager 350, in response to determining that the first risk score indicates that the first process has a greater than threshold (e.g., 90 percent) likelihood of corresponding to malware, updates the one or more security protocols 352 to include ending the first process at the first client device, disabling execution of particular software (e.g., an executable file) associated with the first process at all client devices of the system 100, ending all processes associated with the particular software at all client devices of the system 100, or a combination thereof. The risk manager 350 may thus pre-emptively (e.g., independently of the second risk score) determine that the second process at the second client device of the device 102B is to be ended in response to determining that the first process at the first client device of the device 102A has a high likelihood (e.g., greater than 90 percent) of corresponding to malware and the first process is related to the second process (e.g., initiated by a copy of the particular software).

The risk manager 350 may send commands based on the one or more security protocols 352. For example, the risk manager 350 sends a command 131A to the risk predictor 140A to end the first process at the first client device and to disable execution of the particular software at the first client device. The risk manager 350 sends a command 131B to the risk predictor 140B to end the second process at the second client device and to disable execution of the particular software at the second client device. The risk manager 350 sends a command 131C to the risk predictor 140C to disable acquisition (e.g., download and installation) of the particular software at the third client device. In a particular aspect, the risk manager 350 generates the output data 187 indicating the first risk score and the one or more first activities that resulted in the first risk score. The risk manager 350 provides the output data 187 to the one or more devices 108.

In a particular aspect, the risk manager 350 includes a model updater 354. The model updater 354 generates a model update 355 of the machine-learning model 150 based on the first risk score, the one or more first activities of the first process, the second risk score, one or more second activities of the second process, the third risk score, one or more third activities of the third process, or a combination thereof. For example, the model update 355 indicates updated weights, updated biases, or both, of nodes of the machine-learning model 150. The risk manager 350 sends the model update 355 to the risk predictor 140A, the risk predictor 140B, the risk predictor 140C, or a combination thereof. One or more of the risk predictor 140A, the risk predictor 140B, or the risk predictor 140C updates the machine-learning model 150 based on the model update 355.

In some implementations, the risk manager 350 generates a vulnerability data update 357. For example, the vulnerability data update 357 indicates vulnerability characteristics associated with the particular software. To illustrate, the vulnerability characteristics are based on one or more of the first activities, the first process, or a combination thereof. The risk manager 350 updates the vulnerability data 230 based on the vulnerability data update 357. In some implementations, the risk manager 350 provides the vulnerability data update 357 to the device 102A, the device 102B, the device 102C, or a combination thereof, to update a respective copy of the vulnerability data 230. In some implementations, the risk manager 350 provides the vulnerability data update 357 to a repository that stores the vulnerability data 230.

The management device 106 thus implements system-wide security protocols based on malware processes detected at any client device in the system. The management device 106 also dynamically updates the machine-learning model 150, the vulnerability data 230, or both, based on risk scores associated with multiple client devices.

It should be understood that the management device 106 in communication with three devices 102 that each is associated with a single client device 104 is provided as an illustrative example. In some examples, the management device 106 can be in communication with fewer than three devices 102 or more than three devices 102. In some examples, a particular device 102 can be associated with one or more client devices 104. As an illustrative example, the device 102A generates risk scores corresponding to monitored process activity at a first count of client devices, and the device 102B generates risk scores corresponding to monitored process activity at a second count of client devices. In some aspects, the first count is the same as the second count. In other aspects, the first count can be different from the second count.

Referring to FIG. 4, a method of determining a risk score that indicates a likelihood that a process at a client device corresponds to malware is shown and generally designated 400. In a particular aspect, one or more of the operations of the method 400 are performed by the one or more processors 190, the device 102, the client device 104, the feature data generator 148, the machine-learning model 150, the risk score generator 122, the output generator 182, the risk predictor 140, the system 100 of FIG. 1, or a combination thereof.

The method 400 includes monitoring activity of a process at a client device, at block 402. For example, referring to FIG. 1, the feature data generator 148 collects the process activity data 109N indicating activity of the process 105 at the client device 104. In some implementations, the risk predictor 140 is integrated in a device 102 that is external to the client device 104, and the feature data generator 148 receives the process activity data 109 from the client device 104. In other implementations, the risk predictor 140 is integrated in the client device 104, and the feature data generator 148 collects the process activity data 109 at the client device 104.

The method 400 also includes generating feature data based at least in part on the monitored activity, at block 404. For example, referring to FIGS. 1-2, the feature data generator 148 generates the feature data 118N based at least in part on the monitored activity indicated by the process activity data 109N.

The method 400 also includes processing, using a machine-learning model, the feature data to generate a risk score, the risk score indicating a likelihood that the process corresponds to malware, at block 406. For example, referring to FIG. 1, the risk score generator 122 processes, using the machine-learning model 150, the feature data 118N to generate the risk score 151N. The risk score 151N indicates a likelihood that the process 105 corresponds to malware.

The method 400 further includes sending the risk score to a management device, at block 408. For example, referring to FIG. 1, the risk score generator 122 sends the output data 127 indicating the risk score 151N to the management device 106. In some implementations, the output data 127 selectively includes the process activity data 109N if the risk score 151N exceeds the risk threshold 184.

The method 400 of FIG. 4 improves processing efficiency at the management device 106 by reducing the amount of data the management device 106 has to filter through to determine whether a process at the client device 104 corresponds to (e.g., includes) malware. For example, instead of sending an expansive amount of data (e.g., the process activity data 109N) to the management device 106 for each activity of a process at the client device 104, the risk predictor 140 can perform a determination of the risk score 151N and selectively send the process activity data 109N (or activity data based on the process activity data 109N) to the management device 106 when the risk score 151N exceeds the risk threshold 184. Thus, the management device 106 receives a relatively small amount of data to process and can determine the appropriate security protocols 170 based on the small amount of data.

Referring to FIG. 5, a method of sending a command based on a risk score that indicates a likelihood that a process at a client device corresponds to malware is shown and generally designated 500. In a particular aspect, one or more of the operations of the method 500 are performed by the one or more processors 190, the management device 106, the system 100 of FIG. 1, the risk manager 350, the one or more processors 390 of FIG. 3, or a combination thereof.

The method 500 includes receiving, at a management device from a client device, a risk score that indicates a likelihood of a process corresponding to malware, where the risk score is generated by a machine-learning model based at least in part on monitored activity of the process at the client device, at block 502. For example, referring to FIG. 1, the management device 106 receives from the risk predictor 140, the output data 127 including the risk score 151N that indicates a likelihood of the process 105 corresponding to malware. In some implementations, the output data 127 selectively includes the process activity data 109N if the risk score 151N exceeds the risk threshold 184.

The risk score 151N is generated by the machine-learning model 150 based at least in part on the process activity data 109N. The process activity data 109N indicates monitored activity of the process 105 at the client device 104. In some implementations, the risk predictor 140 is integrated in the client device 104. In other implementations, the risk predictor 140 is external to the client device 104.

The method 500 also includes, based on determining that the risk score is greater than a risk threshold, sending a command to the client device, at block 504. For example, referring to FIG. 1, the management device 106, based on determining that the risk score 151N is greater than the risk threshold 186, sends the command 131 to the client device 104. In some implementations, the management device 106 sends the command 131 to the risk predictor 140 and the risk predictor 140 sends the command 129 to the client device 104.

The method 500 of FIG. 5 improves processing efficiency at the management device 106 by reducing the amount of data the management device 106 has to filter through to determine whether a process at the client device 104 corresponds to (e.g., includes) malware. For example, instead of receiving an expansive amount of data (e.g., the process activity data 109N) at the management device 106 for each activity of a process at the client device 104, the process activity data 109N (or activity data based on the process activity data 109N) is selectively sent by the risk predictor 140 to the management device 106 when the risk score 151N exceeds the risk threshold 184. Thus, the management device 106 receives a relatively small amount of data to process and can determine the appropriate security protocols 170 based on the small amount of data.

The systems and methods illustrated herein may be described in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module or a decision model may take the form of a processing apparatus executing code, an internet based (e.g., cloud computing) embodiment, an entirely hardware embodiment, or an embodiment combining aspects of the internet, software, and hardware. Furthermore, the system may take the form of a computer program product on a computer-readable medium or device having computer-readable program code (e.g., instructions) embodied or stored in the storage medium or device. Any suitable computer-readable medium or device may be utilized, including hard disks, CD-ROM, optical storage devices, magnetic storage devices, and/or other storage media. As used herein, a “computer-readable medium” or “computer-readable device” is not a signal.

Systems and methods may be described herein with reference to screen shots, block diagrams and flowchart illustrations of methods, apparatuses (e.g., systems), and computer media according to various aspects. It will be understood that each functional block of a block diagram and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In conjunction with the described devices and techniques, an apparatus includes means for monitoring activity of a process at a client device. For example, the means for monitoring may include the one or more processors 190, the feature data generator 148, the risk predictor 140, the device 102, the client device 104, the system 100 of FIG. 1, one or more components configured to monitor activity of a process at a client device, or any combination thereof.

The apparatus also includes means for generating feature data based at least in part on the monitored activity. For example, the means for generating feature data may include the one or more processors 190, the feature data generator 148, the risk predictor 140, the device 102, the client device 104, the system 100 of FIG. 1, one or more components configured to generate feature data based at least in part on monitored activity, or any combination thereof.

The apparatus further includes means for processing, using a machine-learning model, the feature data to generate a risk score, the risk score indicating a likelihood that the process corresponds to malware. For example, the means for processing may include the one or more processors 190, the risk score generator 122, the machine-learning model 150, the risk predictor 140, the device 102, the client device 104, the system 100 of FIG. 1, one or more components configured to process, using a machine-learning model, the feature data to generate a risk score, or any combination thereof.

The apparatus also includes means for sending the risk score to a management device.

For example, the means for sending may include the one or more processors 190, the output generator 182, the risk predictor 140, a communication interface, the device 102, the client device 104, the system 100 of FIG. 1, one or more components configured to send the risk score to a management device, or any combination thereof.

Also in conjunction with the described devices and techniques, an apparatus includes means for receiving, at a management device from a client device, a risk score that indicates a likelihood of a process corresponding to malware, where the risk score is generated by a machine-learning model based at least in part on monitored activity of the process at the client device. For example, the means for receiving may include a communication interface, the management device 106, the system 100 of FIG. 1, the risk manager 350, the one or more processors 390 of FIG. 3, one or more components configured to receive a risk score, or any combination thereof.

The apparatus also includes means for sending a command to the client device based on determining that the risk score is greater than a risk threshold. For example, the means for sending may include a communication interface, the management device 106, the system 100 of FIG. 1, the risk manager 350, the one or more processors 390 of FIG. 3, one or more components configured to send a command, or any combination thereof.

Particular aspects of the disclosure are described below in the following examples:

### EXAMPLE 1

A device includes: one or more processors configured to: monitor activity of a process at a client device; generate feature data based at least in part on the monitored activity; process, using a machine-learning model, the feature data to generate a risk score, the risk score indicating a likelihood that the process corresponds to malware; and send the risk score to a management device.

### EXAMPLE 2

The device of Example 1, wherein the activity includes a registry update, a network activity, a file activity, a child process activity, a user activity, or a combination thereof.

### EXAMPLE 3

The device of Example 1 or Example 2, wherein the feature data is based at least in part on a device profile of the client device, and wherein the device profile is based on a type of installed software, a version of the installed software, a developer of the installed software, a type of hardware, a manufacturer of the hardware, a hardware configuration, a configuration setting, a security setting, or a combination thereof, of the client device.

### EXAMPLE 4

The device of any of Example 1 to Example 3, wherein the one or more processors are further configured to: determine that a software is installed at the client device; and access vulnerability data to determine vulnerability characteristics of the software, wherein the feature data is based at least in part on the vulnerability characteristics.

### EXAMPLE 5

The device of any of Example 1 to Example 4, wherein the one or more processors are further configured to, in response to detecting initiation of the process, add a process entry to monitoring data, wherein the process entry includes a process identifier of the process.

### EXAMPLE 6

The device of Example 5, wherein the one or more processors are further configured to, in response to detecting a particular activity of the process, add an activity entry to the monitoring data, the activity entry indicating the particular activity and associated with the process entry, wherein the feature data is based at least in part on the activity entry.

### EXAMPLE 7

The device of Example 6, wherein the one or more processors are further configured to update the activity entry to indicate the risk score.

### EXAMPLE 8

The device of any of Example 5 to Example 7, wherein the machine-learning model generates the risk score based at least in part on a previous risk score of a previous activity entry associated with the process entry.

### EXAMPLE 9

The device of any of Example 5 to Example 8, wherein the one or more processors are further configured to, in response to determining that the risk score is greater than a risk threshold: generate activity data based on one or more activity entries associated with the process entry; and initiate sending of the activity data with the risk score to the management device.

### EXAMPLE 10

The device of any of Example 1 to Example 9, wherein the one or more processors are further configured to, in response to determining that the risk score is greater than a risk threshold, end the process at the client device.

### EXAMPLE 11

The device of any of Example 1 to Example 10, wherein the one or more processors are further configured to: responsive to sending the risk score to the management device, receive an end process command from the management device; and responsive to receiving the end process command, end the process at the client device.

### EXAMPLE 12

The device of any of Example 1 to Example 11, wherein the machine-learning model includes a decision tree model or a gradient boost model.

### EXAMPLE 13

The device of any of Example 1 to Example 12, wherein the one or more processors are integrated in the client device.

### EXAMPLE 14

A method includes: monitoring activity of a process at a client device; generating feature data based at least in part on the monitored activity; processing, using a machine-learning model, the feature data to generate a risk score, the risk score indicating a likelihood that the process corresponds to malware; and sending the risk score to a management device.

### EXAMPLE 15

The method of Example 14, wherein the activity includes a registry update, a network activity, a file activity, a child process activity, a user activity, or a combination thereof.

### EXAMPLE 16

The method of Example 14 or Example 15, wherein the feature data is based at least in part on a device profile of the client device, and wherein the device profile is based on a type of installed software, a version of the installed software, a developer of the installed software, a type of hardware, a manufacturer of the hardware, a hardware configuration, a configuration setting, a security setting, or a combination thereof, of the client device.

### EXAMPLE 17

The method of any of Example 14 to Example 16, further includes: determining that a software is installed at the client device; and accessing vulnerability data to determine vulnerability characteristics of the software, wherein the feature data is based at least in part on the vulnerability characteristics.

### EXAMPLE 18

The method of any of Example 14 to Example 17, further including, in response to detecting initiation of the process, adding a process entry to monitoring data, wherein the process entry includes a process identifier of the process.

### EXAMPLE 19

The method of Example 18, further including, in response to detecting a particular activity of the process, add an activity entry to the monitoring data, the activity entry indicating the particular activity and associated with the process entry, wherein the feature data is based at least in part on the activity entry.

### EXAMPLE 20

The method of Example 19, further including updating the activity entry to indicate the risk score.

### EXAMPLE 21

The method of any of Example 18 to Example 20, wherein the machine-learning model generates the risk score based at least in part on a previous risk score of a previous activity entry associated with the process entry.

### EXAMPLE 22

The method of any of Example 18 to Example 21, further including, in response to determining that the risk score is greater than a risk threshold: generating activity data based on one or more activity entries associated with the process entry; and initiating sending of the activity data with the risk score to the management device.

### EXAMPLE 23

The method of any of Example 14 to Example 22, further including, in response to determining that the risk score is greater than a risk threshold, ending the process at the client device.

### EXAMPLE 24

The method of any of Example 14 to Example 23, further including: responsive to sending the risk score to the management device, receiving an end process command from the management device; and responsive to receiving the end process command, ending the process at the client device.

### EXAMPLE 25

The method of any of Example 14 to Example 24, wherein the machine-learning model includes a decision tree model or a gradient boost model.

### EXAMPLE 26

A non-transitory computer-readable medium stores instructions that, when executed by a processor, cause the processor to perform the method of any of Example 14 to Example 25.

### EXAMPLE 27

An apparatus includes means for carrying out the method of any of Example 14 to Example 25.

### EXAMPLE 28

A device includes: one or more processors configured to: receive, at a management device from a client device, a risk score that indicates a likelihood of a process corresponding to malware, wherein the risk score is generated by a machine-learning model based at least in part on monitored activity of the process at the client device; and based on determining that the risk score is greater than a risk threshold, initiate sending of a command to the client device.

### EXAMPLE 29

The device of Example 28, wherein the one or more processors are further configured to: receive activity data with the risk score from the client device, the activity data indicating one or more activities of the process, wherein the risk score is generated by the machine-learning model based on the one or more activities; generate output data indicating that the one or more activities of the process resulted in the risk score that is greater than the risk threshold; and provide the output data to a display device, a communication device, a user device, a storage device, or a combination thereof.

### EXAMPLE 30

The device of Example 28 or Example 29, wherein the one or more processors are further configured to implement security protocols in response to determining that the risk score is greater than the risk threshold, the security protocols including sending an end process command to the client device, sending a security setting change command to the client device, isolating the client device from a shared network, sending an alert to a user device, displaying output data indicating one or more activities of the process that resulted in the risk score, or a combination thereof.

### EXAMPLE 31

The device of any of Example 28 to Example 30, wherein the one or more processors are further configured to: generate a machine-learning model update based on multiple risk scores and corresponding activity data from a plurality of client devices; and initiate sending of the machine-learning model update to the client device.

### EXAMPLE 32

A method includes: receiving, at a management device from a client device, a risk score that indicates a likelihood of a process corresponding to malware, wherein the risk score is generated by a machine-learning model based at least in part on monitored activity of the process at the client device; and based on determining that the risk score is greater than a risk threshold, sending a command to the client device.

### EXAMPLE 33

The method of Example 32, further including: receiving activity data with the risk score from the client device, the activity data indicating one or more activities of the process, wherein the risk score is generated by the machine-learning model based on the one or more activities; generating output data indicating that the one or more activities of the process resulted in the risk score that is greater than the risk threshold; and providing the output data to a display device, a communication device, a user device, a storage device, or a combination thereof.

### EXAMPLE 34

The method of Example 32 or Example 33, further including implementing security protocols in response to determining that the risk score is greater than the risk threshold, the security protocols including sending an end process command to the client device, sending a security setting change command to the client device, isolating the client device from a shared network, sending an alert to a user device, displaying output data indicating one or more activities of the process that resulted in the risk score, or a combination thereof.

### EXAMPLE 35

The method of any of Example 32 to Example 34, further including: generating a machine-learning model update based on multiple risk scores and corresponding activity data from a plurality of client devices; and sending the machine-learning model update to the client device.

### EXAMPLE 36

A non-transitory computer-readable medium stores instructions that, when executed by a processor, cause the processor to perform the method of any of Example 32 to Example 35.

### EXAMPLE 37

An apparatus includes means for carrying out the method of any of Example 32 to Example 35.

### EXAMPLE 38

A non-transitory computer-readable medium storing instructions that, when executed by one or more processors, cause the one or more processors to: monitor activity of a process at a client device; generate feature data based at least in part on the monitored activity; process, using a machine-learning model, the feature data to generate a risk score, the risk score indicating a likelihood that the process corresponds to malware; and send the risk score to a management device.

### EXAMPLE 39

The non-transitory computer-readable medium of Example 38, wherein the one or more processors are further configured to: responsive to sending the risk score to the management device, receive a security setting change command from the management device; and responsive to receiving the security setting change command, change a security setting at the client device.

### EXAMPLE 40

The non-transitory computer-readable medium of Example 38 or Example 39, wherein the activity includes a registry update, a network activity, a file activity, a child process activity, a user activity, or a combination thereof.

Although the disclosure may include one or more methods, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A device comprising:
one or more processors configured to:
monitor activity of a process at a client device;
generate feature data based at least in part on the monitored activity;
process, using a machine-learning model, the feature data to generate a risk score, the risk score indicating a likelihood that the process corresponds to malware; and
send the risk score to a management device.

2. The device of claim 1, wherein the activity includes a registry update, a network activity, a file activity, a child process activity, a user activity, or a combination thereof.

3. The device of claim 1, wherein the feature data is based at least in part on a device profile of the client device, and wherein the device profile is based on a type of installed software, a version of the installed software, a developer of the installed software, a type of hardware, a manufacturer of the hardware, a hardware configuration, a configuration setting, a security setting, or a combination thereof, of the client device.

4. The device of claim 1, wherein the one or more processors are further configured to:
determine that a software is installed at the client device; and
access vulnerability data to determine vulnerability characteristics of the software, wherein the feature data is based at least in part on the vulnerability characteristics.

5. The device of claim 1, wherein the one or more processors are further configured to, in response to detecting initiation of the process, add a process entry to monitoring data, wherein the process entry includes a process identifier of the process.

6. The device of claim 5, wherein the one or more processors are further configured to, in response to detecting a particular activity of the process, add an activity entry to the monitoring data, the activity entry indicating the particular activity and associated with the process entry, wherein the feature data is based at least in part on the activity entry.

7. The device of claim 6, wherein the one or more processors are further configured to update the activity entry to indicate the risk score.

8. The device of claim 5, wherein the machine-learning model generates the risk score based at least in part on a previous risk score of a previous activity entry associated with the process entry.

9. The device of claim 5, wherein the one or more processors are further configured to, in response to determining that the risk score is greater than a risk threshold:
generate activity data based on one or more activity entries associated with the process entry; and
initiate sending of the activity data with the risk score to the management device.

10. The device of claim 1, wherein the one or more processors are further configured to, in response to determining that the risk score is greater than a risk threshold, end the process at the client device.

11. The device of claim 1, wherein the one or more processors are further configured to:
responsive to sending the risk score to the management device, receive an end process command from the management device; and
responsive to receiving the end process command, end the process at the client device.

12. The device of claim 1, wherein the machine-learning model includes a decision tree model or a gradient boost model.

13. The device of claim 1, wherein the one or more processors are integrated in the client device.

14. A method comprising:
receiving, at a management device from a client device, a risk score that indicates a likelihood of a process corresponding to malware, wherein the risk score is generated by a machine-learning model based at least in part on monitored activity of the process at the client device; and
based on determining that the risk score is greater than a risk threshold, sending a command to the client device.

15. The method of claim 14, further comprising:
receiving activity data with the risk score from the client device, the activity data indicating one or more activities of the process, wherein the risk score is generated by the machine-learning model based on the one or more activities;
generating output data indicating that the one or more activities of the process resulted in the risk score that is greater than the risk threshold; and
providing the output data to a display device, a communication device, a user device, a storage device, or a combination thereof.

16. The method of claim 14, further comprising implementing security protocols in response to determining that the risk score is greater than the risk threshold, the security protocols including sending an end process command to the client device, sending a security setting change command to the client device, isolating the client device from a shared network, sending an alert to a user device, displaying output data indicating one or more activities of the process that resulted in the risk score, or a combination thereof.

17. The method of claim 14, further comprising:
generating a machine-learning model update based on multiple risk scores and corresponding activity data from a plurality of client devices; and
sending the machine-learning model update to the client device.

18. A non-transitory computer-readable medium storing instructions that, when executed by one or more processors, cause the one or more processors to:
monitor activity of a process at a client device;
generate feature data based at least in part on the monitored activity;
process, using a machine-learning model, the feature data to generate a risk score, the risk score indicating a likelihood that the process corresponds to malware; and
send the risk score to a management device.

19. The non-transitory computer-readable medium of claim 18, wherein the one or more processors are further configured to:
responsive to sending the risk score to the management device, receive a security setting change command from the management device; and
responsive to receiving the security setting change command, change a security setting at the client device.

20. The non-transitory computer-readable medium of claim 18, wherein the activity includes a registry update, a network activity, a file activity, a child process activity, a user activity, or a combination thereof.
